(19) United States
(12) Patent Application Publication
(10) Pub. No.: US 2026/0084964 A1
(43) Pub. Date: Mar. 26, 2026

(54) METHOD FOR PREPARING LITHIUM BIS(FLUOROSULFONYL)IMIDE

(71) Applicants: Shanghai Chemspec Corporation, Shanghai (CN); Lanzhou Chemspec New Energy Technology Corporation, Lanzhou (CN)

(72) Inventors: Dong YANG, Shanghai (CN); Shengping LIN, Shanghai (CN); Shaohua YANG, Shanghai (CN); Li HE, Shanghai (CN); Zimin LI, Shanghai (CN); Yunlong YUAN, Shanghai (CN); Jianhua YANG, Shanghai (CN)

(73) Assignees: Shanghai Chemspec Corporation, Shanghai (CN); Lanzhou Chemspec New Energy Technology Corporation, Lanzhou (CN)

(21) Appl. No.: 19/114,782

(22) PCT Filed: Oct. 9, 2023
(86) PCT No.: PCT/CN2023/123591

§ 371 Date: Mar. 24, 2025

(30) Foreign Application Priority Data
Jun. 16, 2023 (CN) 202310718956.4

(51) Int. Cl. C01B 21/093

(52) U.S. Cl. CPC C01B 21/0935

(57) ABSTRACT

A method for preparing lithium bis(fluorosulfonyl)imide, includes reacting bis(fluorosulfonyl)imide with lithium carbonate in a mixed organic solvent to obtain lithium bis(fluorosulfonyl)imide after post-treatment. In the synthetic route of the lithium bis(fluorosulfonyl)imide, the reaction process stays at the stage of lithium bicarbonate, so there is little water in the reaction system, and it is very easy to recover the generated lithium bicarbonate. The process is simple and can be used to prepare lithium bis(fluorosulfonyl)imide of high quality at a high yield.

### FIELD OF TECHNOLOGY

The present disclosure relates to the field of organic chemistry, particularly to a method for preparing lithium bis(fluorosulfonyl)imide.

### BACKGROUND

Lithium-ion batteries, due to their high operating voltage, small size, lightweight, high energy, no memory effect, no pollution, small self-discharge, long cycle life, and other characteristics, are an important type of secondary battery and have been widely used in all aspects of modern production and life. Compared with traditional electrolyte salt LiPF₆, lithium bis(fluorosulfonyl)imide (LiFSI) exhibits better electrical conductivity, higher electrochemical and thermal stability, and hydrolysis resistance. The addition of LiFSI can greatly increase the number of charge/discharge cycles and keep the highly active electrode materials such as high-nickel positive electrodes and high-voltage positive electrodes stable, thereby prolonging the life of batteries, also improving the flame resistance of the electrolyte and enhancing the safety.

Most synthesis methods of LiFSI first synthesize bis(chlorosulfonyl)imide (HClSI), and then react with MFn (where M is an element of Groups 11-15 and Periods 4-6) to prepare the corresponding metal or organic base salt intermediate of bis(fluorosulfonyl)imide, and then conduct a cation exchange reaction with LiOH or Li₂CO₃ to obtain LiFSI (US2013331609, US2012041233, EP2415757, US2011034716). The disadvantage of these methods is that after the exchange reaction reaches equilibrium, it is difficult to carry out completely, and the unreacted intermediate MSFI (where M refers to a metal cation or an organic base cation) is difficult to completely separate from LiSFI to obtain a high-quality product.

LiFSI is prepared from the metal exchange between purified potassium bis(fluorosulfonyl)imide (KFSI) and a lithium salt such as LiClO₄, LiBF₄, lithium bis(oxalate)borate, LiPF₆, etc. However, the potassium ion content in the product is often very high, which affects its practical application, particularly LiClO₄ and the produced KClO₄, both of which pose a certain explosion risk (Electrochimical Acta, 2012, 66, PP. 320-324, Polyhedron, 2006, 25, PP. 1292-1298, CN101747242, CN101747243, CN101654229, CN105523970, CN103910346, CN104495767).

U.S. Pat. No. 8,377,406 discloses a method for preparing LiFSI by directly reacting bis(fluorosulfonyl)imide (HFSI) with lithium carbonate in an aqueous solution. However, this method has an obvious disadvantage in that the HFSI is intensely exothermic when dissolved in water, resulting in the decomposition of HFSI. In U.S. Pat. No. 8,377,406, the technical problem of intense heat release when HFSI is dissolved in water is solved by a method of formulating the aqueous solution of HFSI at ultra-low temperature (−78° C.). However, this method leads to a substantial increase in energy consumption, more importantly, LiFSI has very good water solubility and very low extraction efficiency, which make it unsuitable for industrial production.

In addition, CN 104925765B discloses a method for preparing LiFSI from bis(fluorosulfonyl)imide (HFSI) and lithium carbonate in an organic solvent. However, water would be generated during the preparation process, and the product LiFSI is susceptible to hydrolysis in water. SOCl₂ was employed to remove water, which also brings SO₂, HCl, and other acidic waste gases, requiring high processing costs. Therefore, a new method for preparing lithium bis(fluorosulfonyl)imide is needed, which is simple and environmentally friendly, and improves the yield and quality of lithium bis(fluorosulfonyl)imide.

### SUMMARY

The present disclosure provides a method for preparing lithium bis(fluorosulfonyl)imide, which is simple and environmentally friendly, and can be used to prepare lithium bis(fluorosulfonyl)imide of high quality at a high yield.

The present disclosure provides a method for preparing lithium bis(fluorosulfonyl)imide, which includes performing a reaction on bis(fluorosulfonyl)imide with lithium carbonate in a mixed organic solvent and performing a post-treatment to obtain lithium bis(fluorosulfonyl)imide. The polarities of each solvent in the mixed organic solvent are different.

The reaction equation is as follows:

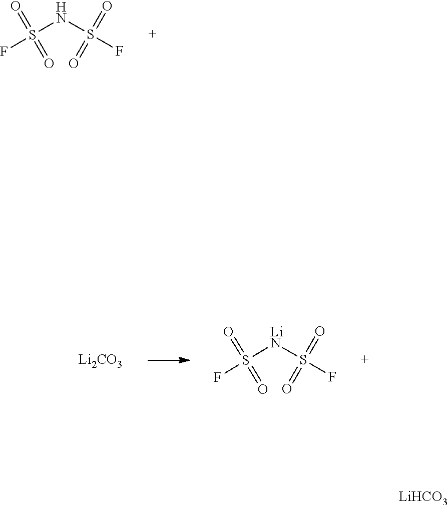

In some embodiments, the mixed organic solvent is a mixture of a solvent A and a solvent B, and the polarity of the solvent A is different from that of the solvent B.

In some embodiments, the molar ratio of lithium carbonate to bis(fluorosulfonyl)imide ranges from 0.5:1 to 20:1.

In some embodiments, the mass ratio of the mixed organic solvent to bis(fluorosulfonyl)imide ranges from 0.1:1 to 20:1.

In some embodiments, the reaction temperature of the reaction ranges from −70° C. to 50° C.

In some embodiments, performing a reaction on bis(fluorosulfonyl)imide with lithium carbonate in a mixed organic solvent includes: dropwise adding bis(fluorosulfonyl)imide into the system of lithium carbonate in the mixed organic solvent.

In some embodiments, the post-treatment includes the following steps: 1) filtering a reaction system after the reaction to obtain a filtrate; 2) adding a drying agent into the filtrate for drying; 3) at the end of drying, performing filtration, concentration and crystallization to obtain lithium bis(fluorosulfonyl)imide.

The method for preparing lithium bis(fluorosulfonyl)imide of the present disclosure can achieve the following effects. 1) By reacting bis(fluorosulfonyl)imide with lithium carbonate in a mixed organic solvent to produce lithium bis(fluorosulfonyl)imide and lithium bicarbonate, almost no water is generated. The post-treatment is simple and the obtained lithium bis(fluorosulfonyl)imide is high in yield and quality. 2) The lithium bicarbonate generated from the reaction can be recovered by a simple process.

### DETAILED DESCRIPTION

The inventors of the present disclosure have found through research that, by reacting bis(fluorosulfonyl)imide with lithium carbonate in a mixed organic solvent, the reaction process could stay at the stage of lithium bicarbonate, from which almost no water would be produced, thereby optimizing the preparation process and obtaining bis(fluorosulfonyl)imide of high quality at a high yield. In addition, it is very easy to recover lithium bicarbonate, thus providing an environmentally friendly process route.

The present disclosure provides a method for preparing lithium bis(fluorosulfonyl)imide (LiFSI), which includes reacting bis(fluorosulfonyl)imide (HFSI) with lithium carbonate (Li₂CO₃) in a mixed organic solvent to obtain lithium bis(fluorosulfonyl)imide after post-treatment, and the polarities of each solvent in the mixed organic solvent are different.

The reaction equation is as follows:

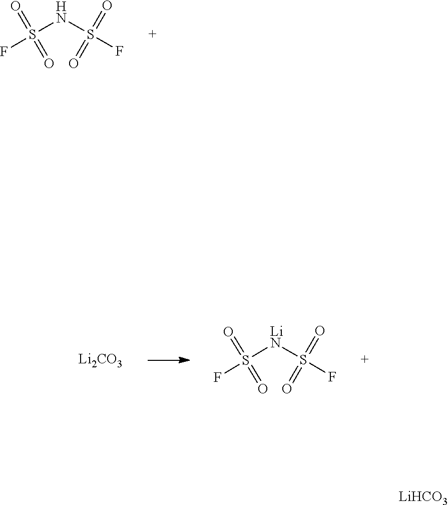

By using the above synthetic route, there is little water in the reaction system, and it is very easy to recover the generated lithium bicarbonate. The reaction process can be controlled by choosing an appropriate reaction system. In some embodiments, the mixed organic solvent is a mixture of solvent A and solvent B, and the polarity of solvent A is different from that of solvent B. It is demonstrated by experiments that, LiFSI has good solubility in some highly polar solvents. However, if a single highly polar solvent is used, it is difficult for the reaction to stay at the stage of LiHCO₃, making LiHCO₃ continue to react with HFSI to produce LiFSI, and simultaneously produce carbon dioxide and water. However, the inventor has found that the reaction of LiFSI with lithium carbonate would easily stay at the stage of LiHCO₃ when organic solvents of different polarities are mixed as the reaction solvent. Of course, the inventor also tried to only use solvents of low polarity, showing that LiFSI is poorly soluble in solvents of low polarity, resulting in LiHCO₃ and LiFSI being precipitated out as solid at the same time and cannot be further separated and purified.

In particular, the solvent A is generally a polar solvent, for example, a solvent containing a polar group such as hydroxyl or carboxyl. In some embodiments, the solvent A is a polar aprotic solvent. In some embodiments, the solvent A is one or more of carbonate solvents, carboxylate solvents, ether solvents, and ketone solvents. The C-chain in the carbonate solvents, carboxylate solvents, ether solvents or ketone solvents can be chosen according to their solubility to the reactants or products. In some embodiments, the polar organic solvent is at least one of dimethyl carbonate, methyl ethyl carbonate, diethyl carbonate, ethylene carbonate, propylene carbonate, methyl formate, ethyl formate, n-propyl formate, isopropyl formate, n-butyl formate, isobutyl formate, tert-butyl formate, methyl acetate, ethyl acetate, n-propyl acetate, isopropyl acetate, n-butyl acetate, isobutyl acetate, tert-butyl acetate, methyl propionate, ethyl propionate, n-propyl propionate, isopropyl propionate, n-butyl propionate, isobutyl propionate, tert-butyl propionate, methyl n-butyrate, ethyl n-butyrate, n-propyl n-butyrate, isopropyl n-butyrate, n-butyl n-butyrate, isobutyl n-butyrate, tert-butyl n-butyrate, methyl iso-butyrate, ethyl iso-butyrate, n-propyl iso-butyrate, iso-propyl iso-butyrate, n-butyl iso-butyrate, iso-butyl iso-butyrate, and tert-butyl iso-butyrate.

The solvent B is at least one of alkanes, cycloalkanes, substituted alkanes (particularly halogenated alkanes), aromatic hydrocarbons, and substituted aromatic hydrocarbons (particularly halogenated aromatic hydrocarbons). In some embodiments, the solvent B is at least one of pentane, hexane, heptane, cyclohexane, methylcyclohexane, dichloromethane (DCM), chloroform, carbon tetrachloride, dichloroethane (DCE), trichloroethane, tetrachloroethane, benzene, toluene, xylene, ethylbenzene, propylbenzene, isopropylbenzene, chlorobenzene and dichlorobenzene.

In some embodiments, the molar ratio of lithium carbonate to bis(fluorosulfonyl)imide ranges from 0.5:1 to 20:1. Optionally, the molar ratio of lithium carbonate to bis(fluorosulfonyl)imide is in range of 0.5:1˜1:1, 1:1˜2:1, 2:1˜8:1, 8:1˜10:1, 8:1˜10:1, or 15:1˜20:1. Considering the economics of the process and the yield and quality of the product, the molar ratio of lithium carbonate to bis(fluorosulfonyl)imide is in range of preferably 3:1˜8:1, more preferably 3:1˜5:1.

In some embodiments, the mass ratio of the mixed solvent to bis(fluorosulfonyl)imide ranges from 0.1:1 to 20:1, and a reasonable mass ratio of the mixed solvent to bis(fluorosulfonyl)imide is chosen by considering the reaction process, the reaction efficiency, the post-treatment efficiency and the yield and quality of the product.

In particular, the mass ratio of the solvent B to bis(fluorosulfonyl)imide is in range of 0.5:1˜10:1, optionally 0.5:1˜0.8:1, 0.8:1˜3:1, 3:1˜8:1, 8:1˜10:1. It is demonstrated through experiments that the reaction process can stay at the stage of lithium bicarbonate by keeping a certain mass ratio of solvent B to bis(fluorosulfonyl)imide.

More particularly, the mass ratio of the solvent A to bis(fluorosulfonyl)imide is in range of 0.1:1˜10:1, optionally 0.5:1˜1:1, 1:1˜5:1, 5:1˜10:1. In some embodiments, the mass ratio of the solvent A to bis(fluorosulfonyl)imide ranges from 2:1 to 4:1, and the mass ratio of solvent A to solvent B ranges from 1:3 to 1:10, preferably 1:4 to 1:7. It is demonstrated through experiments that the good solubility of lithium bis(fluorosulfonyl)imide can be ensured by keeping a certain mass ratio of solvent A to bis(fluorosulfonyl)imide.

Briefly, the reaction process can be made to stay at the stage of lithium bicarbonate by selecting a suitable proportion of mixed solvent and a suitable proportion of reactants. During such a synthetic route, no water would be produced, which eliminates the need to use a drying agent to remove water in the process of reaction, not only simplifies the process, but also improves the yield and quality of lithium bis(fluorosulfonyl)imide.

In some embodiments, the reaction is taken at a temperature from −70° C. to 50° C., optionally −70° C. to −50° C., −50° C. to −30° C., −30° C. to −15° C., −15° C. to 0° C., 0° C. to 20° C. or 20° C. to 50° C. In particular, there is intense heat release when HFSI is dissolved in water, and there would inevitably be a little water in the reaction solvent or during the synthetic route, so maintaining a low temperature to some extent can improve the yield and quality of HFSI. Of course, almost no water would be produced during the synthetic route of the present disclosure, so the temperature can be controlled at −30° C. to 0° C. It should be noted that, it is necessary to maintain the initial temperature of the reaction system, which is −70° C. to −10° C., optionally −70° C. to −50° C., −50° C. to −20° C. or −20° C. to −10° C.

In some embodiments, as described above, to avoid the intense heat release during the dissolution of HFSI, it is preferable to add bis(fluorosulfonyl)imide into the system of lithium carbonate in a mixed organic solvent dropwise at a suitable rate adjusted as desired by the system.

In some embodiments, the time of the aforesaid reaction ranges from 1 to 5 hours. The reaction time can be determined according to the consumption degree of the reactants detected by common detection means, and it is generally maintained at 2.5 to 3.5 hours.

In some embodiments, the post-treatment includes the following steps: 1) filtering a reaction system after the reaction to obtain a filtrate and a filter cake; 2) performing filtration, concentration, and crystallization to obtain lithium bis(fluorosulfonyl)imide.

Specifically, after the reaction, the reaction solution is filtered by a conventional filtration method such as suction filtration or press filtration. The filtered filtrate is concentrated and crystallized to obtain lithium bis(fluorosulfonyl)imide. Specifically, after the filtration, the filtrate is concentrated at atmospheric pressure and/or at reduced pressure and then crystallized by adding a poor solvent which is selected from organic solvents, and preferably selected from alkanes, cycloalkanes, halogenated alkanes, aromatic hydrocarbons, and halogenated aromatic hydrocarbons. In some embodiments, the poor solvent is selected from pentane, hexane, heptane, cyclohexane, methylcyclohexane, dichloromethane, chloroform, carbon tetrachloride, dichloroethane, trichloroethane, tetrachloroethane, benzene, toluene, xylene, ethylbenzene, propylbenzene, isopropylbenzene, chlorobenzene, and dichlorobenzene. After crystallization, solid-liquid separation and drying are performed to obtain lithium bis(fluorosulfonyl)imide.

In some embodiments, during the reaction process, there may be a small amount of water present in the reaction solvent or moisture may be introduced due to the air humidity, as well a trace amount of water may be produced from the reaction. Therefore, performing a post-treatment to obtain lithium bis(fluorosulfonyl)imide further includes adding a drying agent into the filtrate obtained from step 1) for drying, and step 2) is performed after the drying is completed. The drying agent is at least one of metallic lithium, butyl lithium, lithium hydride (LiH), calcium hydride (CaH₂), lithium sulfate (Li₂SO₄), lithium bis(fluorosulfonyl)imide (LiFSI), thionyl chloride, phosgene, diphosgene, triphosgene, oxalyl chloride, and silicon tetrachloride (SiCl₄). At the end of drying, the reaction solution is filtered again by suction filtration and/or press filtration, and the resulting filtrate is further subjected to the concentration and crystallization in step 2). The water in the filtrate is kept below 50 ppm by using a drying agent to ensure the yield and quality of LiFSI. The amount of the drying agent depends on the water in the filtrate. The mass ratio of the drying agent to bis(fluorosulfonyl)imide generally ranges from 0.001:1 to 0.1:1.

It should be noted that, the filter cake in step 1) is dried to obtain lithium carbonate, which can be recycled. Specifically, the reaction equation for the thermal dehydration of LiHCO₃ to generate Li₂CO₃ is as below:

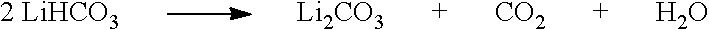

In some embodiments, the filter cake in step 1) is dried by gradient heating from 60° C. to 120° C. to obtain lithium carbonate. In some embodiments, the first gradient is dried at 60° C. to 80° C. for 5 to 8 h, the second gradient is dried at 80° C. to 110° C. for 1 to 3 h, and the third gradient is dried at 110° C. to 120° C. for 2 to 5 h, with LOD<0.1% as the standard (LOD means loss-on-drying). Gradient heating can make the release of CO₂ more smoothly, while if the temperature is raised to the maximum all at once, CO₂ will be released in large quantities, posing a risk of overpressure punching.

Embodiments of the present disclosure are hereinafter described by way of particularly specific examples, and other advantages and effects of the present disclosure may be readily appreciated by those skilled in the art from the content disclosed in the specification. The present disclosure may also be implemented or applied in other specific embodiments, and various details in this specification may be modified or changed in various ways based on different views and applications without departing from the spirit of the present disclosure.

When numerical ranges are given in the embodiments, it is understood that both endpoints of each numerical range and any numerical value between the two endpoints can be selected unless otherwise specified in the present disclosure. Unless otherwise defined, all technical and scientific terms used herein have the same meanings as commonly understood by those skilled in the art. In addition to the specific methods, equipment, and materials used in the embodiments, any methods, equipment, and materials of the prior art that are similar or equivalent to those described in the embodiments of the present disclosure may be used to implement the present disclosure according to the knowledge of a person skilled in the art and the content documented in the present disclosure.

### Example 1

To a 5000 mL glass flask, 2250 g DCE and 450 g methyl formate were added and stirred, and then 740 g Li₂CO₃ was added. The mixture was cooled to −30±5° C., and 452.5 g HFSI was added dropwise into the flask while the temperature was controlled at −30±5° C. After the dropwise addition, the mixture was continually stirred for 3 h while maintaining the temperature and then filtered, to obtain 3018 g filtrate with 552 ppm water in the filtrate, and 737 g filter cake. 0.5 g LiH was added into the filtrate and stirred for 2 h until the water in the filtrate was <50 ppm, then the mixture was filtered to obtain a filtrate. The solvent of the filtrate was removed under reduced pressure, and 1086 g DCE was added to the residue. The mixture was stirred at room temperature for 1 h and then filtered to obtain a filter cake. The filter cake was dried to obtain pure LiFSI 445.3 g in 95.3% yield. The quality data of the pure LiFSI product is as follows: acid value (HF) 12 ppm, chloride 2 ppm, fluoride 8 ppm, sulfate<1 ppm, sodium 3 ppm, potassium 1 ppm, and water 23 ppm. The product meets the indicators specified in the industry standard YS/T 1302-2019.

The filter cake obtained from the first filtration, weighing 737 g, was dried at 60° C. for 7 h, at 100° C. for 2 h, and at 120° C. for 3 h to LOD<0.1%, to obtain 638 g of recovered lithium carbonate by dry weight, with a content of 98.7%.

### Example 2

To a 5000 mL glass flask, 2250 g DCM and 450 g methyl formate were added and stirred, and then 630 g recovered Li₂CO₃ and 110 g fresh Li₂CO₃ were added. The mixture was cooled to −25° C., and 452.5 g HFSI was added dropwise into the flask while the temperature was controlled at −30±5° C. After the dropwise addition, the mixture was stirred for 3 h while maintaining the temperature and then filtered, obtaining 3036 g filtrate with 498 ppm water in the filtrate, and 776 g filter cake. 0.5 g CaH₂ was added into the filtrate and stirred for 2 h until the water in the filtrate was <50 ppm, then filtered to obtain a filtrate. The solvent of the filtrate was removed under reduced pressure, and 1086 g DCE was added to the residue. The mixture was stirred at room temperature for 1 h, and then filtered to obtain a filter cake. The filter cake was dried to obtain 447.0 g of pure LiFSI product, in 95.7% yield. The quality data of the pure LiFSI product was as follows: acid value (HF) 15 ppm, chloride 3 ppm, fluoride 7 ppm, sulfate<1 ppm, sodium 3 ppm, potassium 1 ppm, and water 27 ppm. The product meets the indicators specified in the industry standard YS/T 1302-2019.

The filter cake obtained from the first filtration, weighing 776 g, was dried at 60° C. for 7 h, at 100° C. for 2 h, and at 120° C. for 3 h to LOD<0.1%, to obtain 640 g of recovered lithium carbonate by dry weight, with a content of 98.5%.

### Example 3

To a 1000 mL glass flask, 540 g DCE and 90 g methyl ethyl carbonate were added and stirred, and then 148 g Li₂CO₃ was added. The mixture was cooled to −25° C., and 90.5 g HFSI was added dropwise into the flask while the temperature was controlled at −30±5° C. After the dropwise addition, the mixture was stirred for 3 h while maintaining the temperature and then filtered, to obtain 614 g filtrate with 604 ppm water in the filtrate, and 142 g filter cake. 2.5 g SOCl₂ was added into the filtrate and stirred for 2 h until the water in the filtrate was <50 ppm. The solvent of the filtrate was removed under reduced pressure, and 216 g DCE was added to the residue. The mixture was stirred at room temperature for 1 h, and then filtered to obtain a filter cake. The filter cake was dried to obtain 89.6 g pure LiFSI, in 95.8% yield. The quality data of the pure LiFSI product was as follows: acid value (HF) 35 ppm, chloride 32 ppm, fluoride 5 ppm, sulfate<1 ppm, sodium 2 ppm, potassium 2 ppm, and water 18 ppm. The product meets the indicators specified in the industry standard YS/T 1302-2019.

### Example 4

To a 1000 mL glass flask, 540 g DCE and 90 g dimethyl carbonate were added and stirred, and then 148 g Li₂CO₃ was added. The mixture was cooled to −25° C., and 90.5 g HFSI was added dropwise into the flask while the temperature was controlled at −25° C. After the dropwise addition, the mixture was continually stirred for 3 h while maintaining the temperature and then filtered, to obtain 609 g filtrate with 583 ppm water in the filtrate and 147 g filter cake. 2.5 g SOCl₂ was added into the filtrate and stirred for 2 h until the water in the filtrate was <50 ppm. The reaction solution was degassed for 1 h under reduced pressure, then 0.1 g LiH was added into the residue (for adjusting the acid value and the chloride). The mixture was stirred for 2 h, and then filtered to obtain a filtrate. The solvent of the filtrate was removed under reduced pressure, and then 216 g DCE was added to the residue. The mixture was stirred at room temperature for 1 h, and then filtered to obtain a filter cake. The filter cake was dried to obtain 90.3 g pure LiFSI, in 96.6% yield. The quality data of the pure LiFSI product was as follows: acid value (HF) 9 ppm, chloride 8 ppm, fluoride 3 ppm, sulfate<1 ppm, sodium 3 ppm, potassium 1 ppm, and water 13 ppm. The product meets the indicators specified in the industry standard YS/T 1302-2019.

### Example 5

To a 1000 mL glass flask, 540 g DCE and 90 g butyl acetate were added and stirred, and then 148 g Li₂CO₃ was added. The mixture was cooled to −25° C., and 90.5 g HFSI was added dropwise into the flask while the temperature was controlled at −25° C. After the dropwise addition, the mixture was stirred for 3 h while maintaining the temperature and then filtered, to obtain 614 g filtrate with 604 ppm water in the filtrate and 142 g filter cake. 9.5 g Li₂SO₄ was added into the filtrate and stirred for 2 h until the water in the filtrate was <50 ppm, then filtered to obtain a filtrate. The solvent of the filtrate was removed under reduced pressure, and then 216 g DCE was added to the residue. The mixture was stirred at room temperature for 1 h, and then filtered to obtain a filter cake. The filter cake was dried to obtain 88.4 g pure LiFSI, in 94.5% yield. The quality data of the pure LiFSI was as follows: acid value (HF) 22 ppm, chloride 3 ppm, fluoride 3 ppm, sulfate<1 ppm, sodium 4 ppm, potassium 2 ppm, and water 25 ppm. The product meets the indicators specified in the industry standard YS/T 1302-2019.

### Example 6

To a 1000 mL glass flask, 540 g DCE and 90 g dimethyl carbonate were added and stirred, and then 300 g Li₂CO₃ was added. The mixture was cooled to −25° C., and 90.5 g HFSI was added dropwise into the flask while the temperature was controlled at −25° C. After the dropwise addition, the mixture was stirred for 3 h while maintaining the temperature and then filtered, to obtain 662 g filtrate with 152 ppm water in the filtrate and 327 g filter cake. The solvent of the filtrate was removed under reduced pressure, and 216 g DCE was added to the residue. The mixture was stirred at room temperature for 1 h, and then filtered to obtain a filter cake. The filter cake was dried to obtain 82.5 g pure LiFSI, in 88.3% yield. The quality data of the pure LiFSI was as follows: acid value (HF) 12 ppm, chloride 1 ppm, fluoride 9 ppm, sulfate 5 ppm, sodium 4 ppm, potassium 1 ppm, and water 47 ppm. The product meets the indicators specified in the industry standard YS/T 1302-2019.

### Example 7

To a 500 mL glass flask, 225 g DCE and 45 g methyl acetate were added and stirred, and then 111 g Li₂CO₃ was added. The mixture was cooled to −25° C., and 45.3 g HFSI was added dropwise into the flask while the temperature was controlled at −25° C. After the dropwise addition, the mixture was stirred for 3 h while maintaining the temperature and then filtered, to obtain 296 g filtrate with 257 ppm water in the filtrate and 118 g filter cake. 90 g commercially available LiFSI (water s 20 ppm) was added into the filtrate and stirred for 1 h. The solvent of the filtrate was removed under reduced pressure, and 330 g DCE was added to the residue. The mixture was stirred at room temperature for 1 h, and then filtered to obtain a filter cake. The filter cake was dried to obtain 133.9 g pure LiFSI, with a converted yield of 94.0%. The quality data of the pure LiFSI was as follows: acid value (HF) 8 ppm, chloride 2 ppm, fluoride 11 ppm, sulfate 3 ppm, sodium 2 ppm, potassium 1 ppm, and water 35 ppm. In this example, LiFSI was added to make the product dissolved in the solvent easy to crystallize and precipitate. The product meets the indicators specified in the industry standard YS/T 1302-2019.

### Example 8

To a 500 mL glass flask, 300 g DCE and 45 g methyl acetate were added and stirred, and then 111 g Li₂CO₃ was added. The mixture was cooled to −25° C., and 45.3 g HFSI was added dropwise into the flask while the temperature was controlled at −25° C. After the dropwise addition, the mixture was stirred for 3 h while maintaining the temperature and then filtered to obtain a filtrate, with 317 ppm water in the filtrate. 160 g commercially available LiFSI (water s 20 ppm) was added into the filtrate, stirred for 1 h. The solvent of the filtrate was removed under reduced pressure, and 500 g DCE was added to the residue. The mixture was stirred at room temperature for 1 h, and then filtered to obtain a filter cake. The filter cake was dried to obtain 204.4 g pure LiFSI, with a converted yield of 95.0%. The quality data of the pure LiFSI was as follows: acid value (HF) 11 ppm, chloride 3 ppm, fluoride 7 ppm, sulfate 5 ppm, sodium 2 ppm, potassium 2 ppm, and water 26 ppm. The product meets the indicators specified in the industry standard YS/T 1302-2019.

### Comparative Example 1

To a 1000 mL glass flask, 540 g DCE and 90 g dimethyl carbonate were added and stirred, and then 148 g Li₂CO₃ was added. The mixture was cooled to 0-5° C., and 90.5 g HFSI was added dropwise into the flask while the temperature was controlled at 0-5° C. After the dropwise addition, the mixture was stirred for 3 h while maintaining the temperature and filtered, to obtain 674 g filtrate with 6600 ppm water in the filtrate and 135 g filter cake. The solvent of the filtrate was removed under reduced pressure, and 216 g DCE was added to the residue. After being stirred at room temperature for 1 h, the mixture was divided into two layers, including an upper layer of clear liquid and a lower layer of viscous solid. The filtration of the mixture could not be performed.

### Comparative Example 2

To a 1000 mL glass flask, 540 g DCE and 90 g dimethyl carbonate were added and stirred, and then 148 g Li₂CO₃ was added. The mixture was cooled to −25° C., and 90.5 g HFSI was added dropwise into the flask while the temperature was controlled at −30±5° C. After the dropwise addition, the mixture was stirred for 3 h while maintaining the temperature and then filtered, to obtain 600 g filtrate with 562 ppm water in the filtrate and 143 g filter cake. The solvent of the filtrate was removed under reduced pressure, and 216 g DCE was added to the residue. The mixture was stirred at room temperature for 1 h, and then filtered to obtain a filter cake. The filter cake was dried to obtain 87.2 g pure LiFSI. The quality data of the pure LiFSI was as follows: acid value (HF) 53 ppm, chloride 2 ppm, fluoride 38 ppm, sulfate 61 ppm, sodium 2 ppm, potassium 1 ppm, and water 57 ppm. The amounts of water and sulfate in the product were unqualified, exceeding the indicators specified in the industry standard YS/T 1302-2019.

### Comparative Example 3

To a 1000 mL glass flask, 450 g dimethyl carbonate was added and stirred, and then 148 g Li₂CO₃ was added. The mixture was cooled to −25° C., and 90.5 g HFSI was added dropwise into the flask while the temperature was controlled at −25° C. After the dropwise addition, the mixture was stirred for 3 h while maintaining the temperature and then filtered, to obtain 528 g filtrate with 8210 ppm water in the filtrate and 139 g filter cake. 34.4 g SOCl₂ was added into the filtrate and stirred for 12 h until the water in the filtrate was <50 ppm. The solvent of the filtrate was removed under reduced pressure, and 216 g DCE was added to the residue. The mixture was stirred at room temperature for 1 h, and then filtered to obtain a filter cake. The filter cake was dried to obtain 87.1 g pure LiFSI, in 92.2% yield. The quality data of the pure LiFSI was as follows: acid value (HF) 174 ppm, chloride 144 ppm, fluoride 57 ppm, sulfate 61 ppm, sodium 2 ppm, potassium 2 ppm, and water 24 ppm. The product does not meet the indicators specified in the industry standard YS/T 1302-2019.

The above examples are intended to illustrate the disclosed embodiments of the present disclosure and should not be construed as a limitation of the invention. Furthermore, the various modifications set forth herein as well as variations of the method of the invention will be apparent to those skilled in the art without departing from the scope and spirit of the invention. Although the present disclosure has been specifically described in connection with a variety of specific preferred embodiments of the invention, it is understood that the invention should not be limited to these specific embodiments. Indeed, various modifications as described above that would be obvious to those skilled in the art to realize the invention should be included within the scope of the present disclosure.

1. A method for preparing lithium bis(fluorosulfonyl)imide, comprising:
performing a reaction on bis(fluorosulfonyl)imide with lithium carbonate in a mixed organic solvent, and performing a post-treatment to obtain lithium bis(fluorosulfonyl)imide, wherein polarities of each solvent in the mixed organic solvent are different;
wherein a reaction equation is as below:

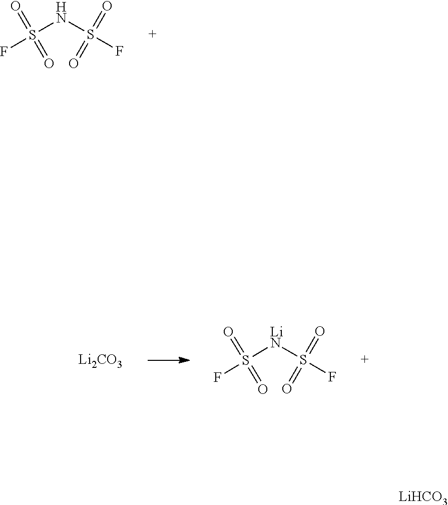

2. The method of claim 1, further comprising at least one of the following:
a1) the mixed organic solvent is a mixture of a solvent A and a solvent B, wherein the polarity of the solvent A is different from that of the solvent B;
a2) a molar ratio of lithium carbonate to bis(fluorosulfonyl)imide ranges from 0.5:1 to 20:1;
a3) a mass ratio of the mixed organic solvent to bis(fluorosulfonyl)imide ranges from 0.1:1 to 20:1;
a4) the temperature of the reaction ranges from −70° C. to 50° C.;
a5) the time of the reaction ranges from 1 to 5 h;
a6) performing a reaction on bis(fluorosulfonyl)imide with lithium carbonate in a mixed organic solvent comprises: dropwise adding bis(fluorosulfonyl)imide into the mixed organic solvent containing lithium carbonate;
a7) performing a post-treatment to obtain lithium bis(fluorosulfonyl)imide comprises the following steps: 1) filtering a reaction system after the reaction to obtain a filtrate and a filter cake; 2) performing filtration, concentration, and crystallization to obtain lithium bis(fluorosulfonyl)imide.

3. The method of claim 2, wherein a1) further comprises at least one of the following:
a11) the solvent A is at least one of carbonate solvents, carboxylate solvents, ether solvents, and ketone solvents; and the solvent B is at least one of alkanes, cycloalkanes, substituted alkanes, aromatic hydrocarbons, and substituted aromatic hydrocarbons;
a12) a mass ratio of the solvent A to bis(fluorosulfonyl)imide is in a range of 0.1:1˜10:1;
or a mass ratio of the solvent A to bis(fluorosulfonyl)imide 0.5:1˜8:1;
or a mass ratio of the solvent A to bis(fluorosulfonyl)imide 0.8:1˜3:1;
a13) a mass ratio of the solvent B to bis(fluorosulfonyl)imide is in a range of 0.5:1˜10:1;
or a mass ratio of the solvent B to bis(fluorosulfonyl)imide is 1:1˜5:1;
or a mass ratio of the solvent B to bis(fluorosulfonyl)imide is 2:1˜4:1.

4. The method of claim 3, wherein the solvent A is at least one of dimethyl carbonate, methyl ethyl carbonate, diethyl carbonate, ethylene carbonate, propylene carbonate, methyl formate, ethyl formate, n-propyl formate, isopropyl formate, n-butyl formate, isobutyl formate, tert-butyl formate, methyl acetate, ethyl acetate, n-propyl acetate, isopropyl acetate, n-butyl acetate, isobutyl acetate, tert-butyl acetate, methyl propionate, ethyl propionate, n-propyl propionate, isopropyl propionate, n-butyl propionate, isobutyl propionate, tert-butyl propionate, methyl n-butyrate, ethyl n-butyrate, n-propyl n-butyrate, isopropyl n-butyrate, n-butyl n-butyrate, isobutyl n-butyrate, tert-butyl n-butyrate, methyl iso-butyrate, ethyl iso-butyrate, n-propyl iso-butyrate, iso-propyl iso-butyrate, n-butyl iso-butyrate, iso-butyl iso-butyrate, and tert-butyl iso-butyrate.

5. The method of claim 3, wherein the solvent B is at least one of pentane, hexane, heptane, cyclohexane, methylcyclohexane, dichloromethane, chloroform, carbon tetrachloride, dichloroethane, trichloroethane, tetrachloroethane, benzene, toluene, xylene, ethylbenzene, propylbenzene, isopropylbenzene, chlorobenzene, and dichlorobenzene.

6. The method of claim 2, further comprising at least one of the following:
a21) in a2), the molar ratio of lithium carbonate to bis(fluorosulfonyl)imide ranges from 1:1 to 15:1; or the molar ratio of lithium carbonate to bis(fluorosulfonyl)imide ranges from 2:1 to 10:1;
a41) in a4), the temperature of the reaction ranges from −50° C. to 20° C.; or the temperature of the reaction ranges from −30° C. to 0° C.

7. The method of claim 2, wherein performing a post-treatment to obtain lithium bis(fluorosulfonyl)imide further comprises adding a drying agent into the filtrate obtained from step 1) for drying, wherein step 2) is performed after the drying is completed.

8. The method of claim 7, wherein the drying agent is at least one of metallic lithium, butyl lithium, lithium hydride, calcium hydride, lithium sulfate, lithium bis(fluorosulfonyl)imide, thionyl chloride, phosgene, diphosgene, triphosgene, oxalyl chloride, and silicon tetrachloride; and
a mass ratio of the drying agent to bis(fluorosulfonyl)imide ranges from 0.001 to 0.1:1.

9. The method of claim 2, wherein a solvent for crystallization is a poor solvent for lithium bis(fluorosulfonyl)imide.

10. The method of claim 2, wherein performing a post-treatment to obtain lithium bis(fluorosulfonyl)imide further comprises drying the filter cake obtained from step 1) to obtain lithium carbonate; wherein the filter cake obtained from step 1) is dried by gradient heating with a temperature ranging from 60° C. to 120° C. to obtain lithium carbonate.

11. The method of claim 2, wherein the solvent for crystallization is at least one of alkanes, cycloalkanes, substituted alkanes, aromatic hydrocarbons, and substituted aromatic hydrocarbons.

12. The method of claim 2, wherein the solvent for crystallization is at least one of pentane, hexane, heptane, cyclohexane, methylcyclohexane, dichloromethane, chloroform, carbon tetrachloride, dichloroethane, trichloroethane, tetrachloroethane, benzene, toluene, xylene, ethylbenzene, propylbenzene, isopropylbenzene, chlorobenzene, and dichlorobenzene.
